(19) United States
(12) Patent Application Publication
(10) Pub. No.: US 2010/0191765 A1
(43) Pub. Date: Jul. 29, 2010

(54) System and Method for Processing Images

(75) Inventors: Zhen-Qi Gan, Carrollton, TX (US); Derek C. Cress, Dallas, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/359,568

(22) Filed: Jan. 26, 2009

(51) Int. Cl. G06F 17/30

(52) U.S. Cl. 707/770; 707/E17.019; 707/E17.014

(57) ABSTRACT

A method for processing digital images includes receiving from one of a plurality of sensors a first image in a first format. A first set of metadata is associated with the first image. The method also includes generating a second set of metadata based on at least the first set of metadata and a configuration file. The configuration file identifies metadata to be included in the second set of metadata. Additionally, the method includes converting the first image in a first format into a second image in a second format and storing the second set of metadata in a metadata database. The method further includes receiving search parameters from clients, identifying one or more sets of metadata corresponding to the search parameters, and transmitting to a client one or more images associated with the identified sets of metadata.

### GOVERNMENT RIGHTS

This invention was made with Government support under the terms of Contract No. F19628-03-D-0015-0064 awarded by the U.S. Air Force. The U.S. Government may have certain rights in this invention.

### TECHNICAL FIELD OF THE INVENTION

This invention relates generally to digital image storing an processing, and more particularly to a method and system for converting digital images from one format to another and storing searchable metadata corresponding to the converted digital images.

### BACKGROUND OF THE INVENTION

The DCGS Integration Backbone is a repository for all sources of intelligence information and is the emerging basis for the DCGS intelligence community accesses information over the Global Information Grid (GIG). However, it lacks a capability to store and disseminate imagery in a timely and bandwidth-efficient manner. The NITF Store Accessory of the DCGS Integration Backbone significantly shortens the timeframe of imagery dissemination to war-fighters.

### SUMMARY OF THE INVENTION

The present invention provides a method and system for digital image processing, storage, and searching that substantially eliminates or reduces at least some of the disadvantages and problems associated with previous methods and systems for digital image processing.

In accordance with one embodiment of the present invention, a method for processing digital images includes monitoring a digital image store for arriving images, retrieving the digital image, storing the image in a digital image store, read metadata corresponding to the image, converting the digital image into another format, and storing the second digital image. The method also includes storing the metadata in a searchable database of metadata.

In accordance with another embodiment of the present invention, a system for processing digital images includes one or more processors operable to monitor an image data storage device for arriving images, retrieve a digital image, store the digital image, read metadata corresponding to the image, convert the digital image into another format, and store the converted digital image onto a digital image data storage device. The processor is further operable to store the extracted metadata in a searchable data storage device.

Important technical advantages of certain aspects of the present invention include providing a template-based approach to extracting digital image metadata. Other technical advantages of certain aspects of the present invention include providing a user with the option to view one or more differently sized images quickly and efficiently. Other technical advantages include providing the user the ability to search for images based on metadata contained in the images.

Other technical advantages of the present invention will be readily apparent to one skilled in the art from the following figures, description, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantage, reference is now made to the following description, taken in conjunction with the accompanying drawings, in which:

FIG. 1 is a block diagram illustrating an image processing and storage system, including a sensor, a digital image storage device, a processor for processing digital images according to a configuration file, and a storage for metadata information corresponding to processed digital images;

FIG. 2 is a block diagram illustrating the processor of FIG. 1 in more detail, including aspects of the present invention; and

FIG. 3 is a flow chart illustrating a method for processing and storing digital images, in accordance with another embodiment of the present invention.

FIG. 4 is a flow chart illustrating a method for searching and retrieving digital images, in accordance with another embodiment of the present invention.

### DETAILED DESCRIPTION OF THE INVENTION

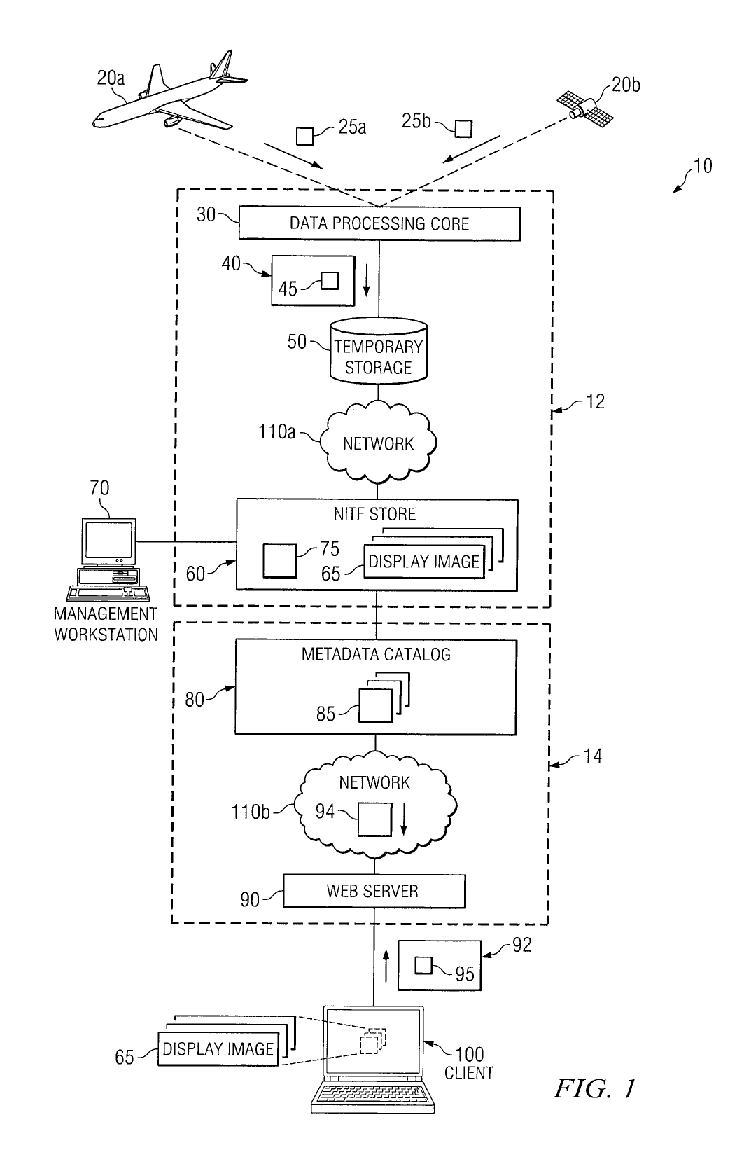

FIG. 1 illustrates a particular embodiment of a system 10 for processing image data 25a and 25b generated by sensors 20a and 20b and for processing metadata associated with image data 25a and 25b. System 10 includes an image processing sub-system 12, which may in particular embodiments include a data processing core 30, a temporary storage 50, and a NITF store 60. In particular embodiments, system 10 may also include a database storage sub-system 14, which may include a metadata catalog 80, a web server 90, and a network 110b. System 10 may also include one or more sensors 20 and a client 100. To facilitate the dissemination of imagery in a timely and bandwidth-efficient manner, system 10 may convert image data 25a and 25b generated by sensor 20 into display image 65 suitable for display on one or more types of client(s) 100. Additionally, system 10 may generate metadata associated with display images 65. This metadata may be searched by client 100 providing a flexible process by which users of client 100 may identify and retrieve display images 65 of interest.

Sensors 20a and 20b (each of which may be referred to generically as a “sensor 20” or collectively as “sensors 20”) generate image data 25a and 25b and send image data 25a and 25b to image processing sub-system 12. In particular embodiments, sensors 20 generate metadata associated with each generated image data 25a and 25b. Sensors 20 may represent any type of devices appropriate to generate images, including but not limited to digital cameras, film cameras, satellite imaging systems, radar imaging systems, infrared imaging systems, sonar imaging systems, x-ray imaging systems, video cameras and/or imaging systems having object-recognition and identification technology. In general, however, sensor 20 may represent any appropriate combination of hardware, software and/or encoded logic suitable to provide the described functionality.

Sensors 20 may be located in any location suitable for generating images, including but not limited to airborne sensors, sensors mounted on vehicles, underwater sensors, or extra-terrestrial sensors. Sensors 20 may couple to the image processing sub-system 12 through a dedicated connection (wired or wireless), or may connect to the image processing sub-system 12 only as necessary to transmit image data. Although FIG. 1 illustrates for purposes of example a particular number and types of sensors 20, alternative embodiments of system 10 may include any appropriate number and suitable types of sensors 20.

Image data 25a and 25b (each of which may be referred to generically as a “image data 25” or collectively as “image data 25”) are generated by sensors 20 and received by image processing sub-system 12. Image data 25 may represent any appropriate type of data describing a person, object, location, or other item of interest. Examples of image data 25 may include data associated with photographs, video footage, audio recordings, radar or sonar readings, and/or any other data describing an item of interest that may be generated by sensors 20. Furthermore, depending on the configuration and capabilities of sensors 20 and system 10 generally, image data 25 may represent data transmitted by sensors 20 as a file, in a datastream, as a series of one or more packets, or as information structured in any other suitable manner.

Data processing core 30 receives image data 25 from sensor 20, processes image data 25, and transmits received image 40 to temporary storage 50. Data processing core 30 may represent any type of server suitable to receive and process image data 25 generated by sensor 20. Examples of data processing core 30 include, but are not limited to, laptops, workstations, stand-alone servers, blade servers, or server farms suitable to perform the described functionality. In general, data processing core 30 may include any appropriate combination of processor, memory, and software suitable to perform the described functionality.

Received image 40 is an image generated by data processing core 30 based on image data 25 collected by one or more sensors 20. Received image 40 may be generated by data processing core 30 in any suitable manner based on the configuration and capabilities of sensors 20 and data processing core 30. In particular embodiments, received image 40 may be an image file created by data processing core 30 as a mosaic of several sets of image data 25 transmitted by a particular sensor 20. Furthermore, in particular embodiments, sensors 20 may themselves be capable of forming complete images, and thus, received image 40 may be identical to image data 25 generated by sensors 25.

Received metadata 45 is information generated by sensor 20 or data processing core 30 and associated with a particular received image 40. Received metadata 45 describes characteristics of the associated received image 40, characteristics of the sensor 20 that generated the image data 25 of the associated received image 40, the circumstances or environment in which the relevant sensor 20 captured the associated image data 25, or any other appropriate information about the associated image data 25 or received image 40. In particular embodiments, received metadata 45 may, for example, describe the time image data 25 was captured by the relevant sensor 20, the location in which the relevant sensor 20 captured image data 25, the resolution in which image data 25 was captured, characteristics of sensor 20 that captured image data 25, the geographic area associated with image data 25, any object depicted in image data 25, a sequence number image data 25 may pertain to, a relevant security level of image data 25, the orientation of the relevant sensor 20, or the position of the relevant sensor 20. Received metadata 45 may be embedded in received image 40 and transmitted to other elements of system 10 as part of received image 40, or may be transmitted to other elements of system 10 separately from received image 40. In general, however, received metadata 45 may describe any aspect of image data 25, sensor 20, the environment in which the image data was captured, or any other appropriate characteristic suitable for use in system 10.

Temporary storage 50 receives received image 40 from data processing core 30 and stores received image 40. Temporary storage 50 may represent or include any appropriate type of memory device including, for example, any collection and arrangement of volatile or non-volatile, local or remote devices suitable for storing data, such as random access memory (RAM) devices, read-only memory (ROM) devices, magnetic storage devices, optical storage devices, or any other suitable data storage devices. Additionally, although each are shown as a single element in system 10, the memory device or devices may each represent a plurality of devices and may be distributed across multiple locations within system 10. For example, in particular embodiments, one or more of these content stores may represent a network-attached storage (NAS) or portion thereof. Although shown in FIG. 1 as being external to data processing core 30, in particular embodiments, temporary storage 40 may be located within data processing core 30.

Network 110a and 110b represent any form of communication network supporting circuit-switched, packet-based, and/or any other suitable type of communication. Although shown in FIG. 1 as a single element, network 110a and 110b may each represent one or more separate networks including all or parts of various different networks that are separated and serve different image processing sub-systems 12 and database storage sub-systems 14. Network 110a and 110b may include routers, hubs, switches, gateways, call controllers and/or any other suitable components in any suitable form or arrangement. In general, network 110a and 110b may comprise any combination of public or private communication equipment such as elements of the public switched telephone network (PSTN), a global computer network such as the Internet, a local area network (LAN), a wide area network (WAN), or other appropriate communication equipment.

Additionally, although FIG. 1 indicates a particular configuration of elements directly connected to and/or interacting with networks 110a and 110b, networks 110a and 110b may connect directly or indirectly and/or interact with any appropriate elements of system 10. For example, although FIG. 1 shows NITF store 60 connected directly to the metadata catalog 80, NITF store 60 may in particular embodiments connect to metadata catalog 80 over network 110a or 110b. Thus, the components of system 10 may be arranged and configured in any appropriate manner to communicate with one another over network 110a and 110b and/or over direct connections between the relevant components.

NITF store 60 converts received images 40 into display images 65 that are suitable for display on client 100 and generates processed metadata 85 associated with each display image 65. NITF store 60 may be any type of device suitable to perform the described functionality including, but not limited to, workstations, laptops, blade servers, server farms, or standalone servers. Although shown in FIG. 1 as a single component, in particular embodiments, NITF store 60 may represent functionality provided by several separate physical components. More generally, NITF store 60 may represent any appropriate combination of software and/or hardware suitable to provide the described functionality.

Display image 65 is a digital image generated by database storage sub-system 14 and suitable for display by client 100. In particular embodiments, display image 65 may be a digital image in a variety of formats, including, but not limited to, Graphic Interchange Format (GIF), Portable Network Graphics (PNG), Raw Image Format (RAW), Joint Photographic Experts Group (JPG), Motion Picture Experts Group (MPEG), and Tagged Image File Format (TIFF). In general, display image 65 may be of any appropriate digital image format suitable for display by client 100. Display image 65 may represent one or more images of differing resolutions, each corresponding to the same received image 40.

Management workstation 70 facilitates management of NITF store 60. In particular embodiments, management workstation 70 may be a workstation, a laptop, a stand-alone server and/or portable electronic device. In general, management workstation 70 may be any appropriate combination of hardware and/or software suitable to provide the described functionality. In particular embodiments, a user may be able to modify configuration file 75 on NITF store 60 using management workstation 70. As discussed further below, configuration file 75 may conditionally determine metadata to be generated by NITF store 60 based on received metadata 45 associated with received image 40. Although depicted in FIG. 1 as being directly connected to NITF store 60, in particular embodiments, management workstation 70 may be indirectly connected to NITF store 60 through network 110a or any other appropriate communication network.

Metadata catalog 80 receives and stores metadata generated by NITF store 60 in a database or other memory structure. Additionally, metadata catalog 80 receives search parameters 95 from client 100 and transmits image identifier 94 indicating a path to images corresponding to metadata search parameters 95. Metadata catalog 80 may be any device suitable to perform the described functionality, including, but not limited to, workstations, laptops, blade servers, server farms, or standalone servers. In general, however, metadata catalog 80 may be any appropriate combination of software and hardware suitable to provide the described functionality. Although shown in FIG. 1 as a separate component, in particular embodiments, metadata catalog 80 may represent functionality provided by several separate physical components. Additionally, metadata catalog 80 may be located within NITF store 60 and/or any other suitable device.

Web server 90 receives search requests 92 from client 100 and sends search parameters 95 to metadata catalog 80. Additionally, web server 90 receives display image 65 from image processing sub-system 12 or database storage sub-system 14 and transmits web pages to client 100. Examples of web server 90 include, but are not limited to, servers, workstations, laptops, blade servers, server farms and/or standalone servers. In general, however, web server 90 may be any combination of hardware and/or software suitable to provide the described functionality. Additionally, although depicted in FIG. 1 as being connected through network 110b to metadata catalog 80, web server 90 may be connected directly to metadata catalog 80, or through any other appropriate communication network.

Client 100 sends metadata search parameters 95 to web server 90 and displays display image 65 generated by NITF store 60. Client 100 may represent any type of device appropriate to display one or more types of image formats and sizes used in system 10. Examples of clients 100 may include, but are not limited to, laptop computers, desktop computers, portable data assistants (PDAs) video enabled telephones, and/or portable media players. In general, client 100 may include any appropriate combination of hardware, software, and/or encoded logic suitable to provide the described functionality. Client 100 may couple to web server 90 directly or indirectly over network 110b. Client 100 may couple to network 110b through a dedicated connection, wired or wireless, or may connect to network 110b only as needed to receive images. For example, certain types of client 100, such as a portable electronic device, may connect temporarily to network 110b to receive images, but then disconnect before displaying the image. Although FIG. 1 illustrates, for purposes of example, a particular number and type of client 100, alternative embodiments of system 10 may include any appropriate number and type of client 100. In particular embodiments, client 100 may be capable of receiving and/or displaying images associated with particular file formats, file types, and/or resolutions and/or having other appropriate characteristics.

In operation, system 10 converts image data 25 generated by sensor 20 into a format suitable for viewing by client 100. In particular embodiments, NITF store 60 converts received image 40 from a proprietary image format used by sensor 20 into a variety of commonly-used image formats in a variety of image resolutions or sizes. Additionally, NITF store 60 generates processed metadata 85 associated with the received image 40 and display image 65 based on metadata provided by sensor 20 and/or metadata independently generated by NITF store 60. NITF store 60 stores processed metadata 85 associated with display image 65 on a searchable metadata database catalog 80. By converting images into a variety of different sizes and storing metadata associated with images, NITF store 60 allows client 100 to search and access images in a timely and bandwidth-efficient manner.

An example of this process, as implemented by a particular embodiment of system 10, is illustrated in FIG. 1. As shown in FIG. 1, sensor 20 generates image data 25 and transmits image data 25 to image processing sub-system 12. Image data 25 generated by sensor 20 may be generated in a variety of proprietary image formats and may be of any appropriate format suitable for use in system 10. Sensor 20 may send multiple sets of image data 25 to image processing sub-system 12. In particular embodiments, data processing core 30 may combine multiple sets of image data 25 into a single mosaicked image. Additionally, sensor 20 may operate with object recognition technology suitable for automatically generating metadata associated with received image 40 that corresponds to recognized objects.

Data processing core 30 receives and processes image data 25 generated by sensor 20, and transmits received image 40 to temporary storage 50. In particular embodiments, data processing core 30 may assemble several sets of image data 25 received from sensor 20 into a mosaicked image, and transmit received image 40 to temporary storage 50. In particular embodiments, data processing core 30 may receive image data 25 from sensor 20 and transmit an identical received image 40 to temporary storage 50 without altering image data 25. In general however, data processing core 30 may process image data 25 in any appropriate manner suitable for use in system 10.

Temporary storage 50 receives received image 40 from data processing core 30 and indexes received image 40 according to chronological date. Temporary storage 50 serves as a buffer to ensure no loss of imagery or to reduce the loss of imagery during an incoming image surge. In particular embodiments, temporary storage 50 may store received image 40 in a particular area located in a local storage device. For example, temporary storage 50 may store received image 40 in an ingest area. In particular embodiments, temporary storage 50 may store received image 40 until transferred to NITF store 60. Once transferred to NITF store 60, temporary storage 50 may remove received image 40.

NITF store 60 processes received image 40 generated by data processing core 30. As an example, NITF store 60 may monitor temporary storage 50 for a new image received from data processing core 30. In particular embodiments, once NITF store 60 determines that a new image is present in temporary storage 50, NITF store 60 may transfer the image to a storage device local to NITF store 60. In particular embodiments, NITF store 60 may be capable of segregating particular images into different security levels, accessible only to users with appropriate security clearances. NITF store 60 may transfer the image 120a from temporary storage 50 to NITF store 60 through any appropriate transfer protocol, including, but not limited to, File Transfer Protocol (FTP). Additionally, NITF store 60 may receive and process multiple images separately or concurrently.

In particular embodiments, NITF store 60 converts received image 40 from a proprietary format used by sensor 20 into display image 65 which can be displayed by client 100. Display image 65 may represent image or image information stored in a commonly-used digital image format, including but not limited to, Graphic Interchange Format (GIF), Portable Network Graphics (PNG), Raw Image Format (RAW), Joint Photographic Experts Group (JPG), Motion Picture Experts Group (MPEG), and Tagged Image File Format (TIFF). NITF store 60 may convert a particular received image 40 into multiple display images 65 having differing sizes and/or resolutions. Thus, in particular embodiments, display image 65 may refer to one or more identical images of differing resolutions and/or sizes.

For example, in particular embodiments, NITF store 60 generates three different display images 65 for each received image 40, each version having a different size and/or resolution. One image represents a default display image 65 (e.g., a thumbnail version of the relevant display image 65) that may be transmitted to client 100 as part of an initial response to a search request from client 100. As described further below, client 100 or a user of client 100 may then select an appropriate size or resolution for the requested image and retrieve another version of the relevant display image 65 having the requested size or resolution.

In addition to generating one or more display images 65, NITF store 60 may read received metadata 45 associated with received image 40 and generate processed metadata 85 to be associated with display image 65 based on received metadata 45. In particular embodiments, NITF store 60 may generate processed metadata 85 by referencing configuration file 75. In particular embodiments, configuration file 75 represents information stored in a text-file format such as XML format. In general, however, configuration file 75 may be any appropriate type of configuration file suitable for operation in system 10. Configuration file may be located in NITF store 60 and configurable by management workstation 70.

In particular embodiments, configuration file 75 may specify conditional metadata fields to be generated based on metadata fields associated with received image 40. For example, a first sensor 20 may generate metadata that contains fewer, more or different fields of metadata than a second sensor 20. As a result, configuration file 75 may indicate to NITF store 60 that a particular field of processed metadata 85 should be generated only if a particular condition is satisfied. For example, configuration file 75 may indicate that NITF store 60 should generate a particular element of processed metadata 85 only if the sensor 20 that generated the associated image data 25 was of a particular type, if a particular element of received metadata 45 was received for the relevant image data 25, if a particular element of received metadata 45 has a certain value, or if any other appropriate condition is satisfied. Thus, configuration file 75 may include conditional metadata fields that operate to generate different types of processed metadata 85 depending on whether received image 40 is received from a first sensor 20 or second sensor 20 or some other predetermined condition is satisfied.

Metadata catalog 80 stores and indexes processed metadata 85 generated by NITF store 60. Once NITF store 60 generates processed metadata 85, NITF store 60 may transmit processed metadata 85 to metadata catalog 80. In particular embodiments, metadata catalog 80 may store and index metadata information on a local storage. Processed metadata 85 may be indexed by associating in an electronic database a set of processed metadata 85 with a stored display image 65 on NITF store 60. Stored processed metadata 85 is thus associated with display image 65. Processed metadata 85 may be indexed by sensor type, by security level, chronologically, or by any other appropriate manner. Once processed metadata 85 has been stored in metadata catalog 80, metadata catalog 80 may respond to searches related to stored processed metadata 85.

For example, client 100 may communicate a search request 92 containing metadata search parameters 95 to web server 90. Client 100 may communicate search request 92 to web server 90 by any appropriate technique, including but not limited to Hypertext Transfer Protocol (HTTP). Web server 90 may transmit search parameters 95 in search request 92 to metadata catalog 80. Search request 92 may represent any appropriate collection of information suitable to initiate a search of metadata and/or images. Metadata catalog 80 may receive search request 92 from web server 90. Metadata catalog 80 may then search an index of metadata for sets of processed metadata 85 corresponding to search request 92. Metadata catalog 80 may transmit to web server 90 image identifier(s) 94 which indicates a path to one or more of display image 65 on NITF store 60. Web server 90 may retrieve one or more of display image 65 by referencing an image path indicated in image identifier(s) 94. Web server 90 may transmit one or more of display image 65 located at the indicated image path file(s) to client 100. In particular embodiments, client 100 may display one or more of display image 65 received from web server 90. Client 100 may then receive selection information from a user indicating which resolution size of display image 65 to display.

Additionally, in particular embodiments, management workstation 70 may manage or facilitate management of NITF store 60 in processing received image files 40. For example, in particular embodiments, an operator may, using management workstation 70, modify configuration file 75 to enable NITF store 60 to read a different set of metadata generated by sensors 20. As a result, if a new sensor 20 is added to system 10, the operator may modify configuration file 75 using management workstation 70 to allow processing of additional types of metadata generated by the new sensor 20 or to supplement the metadata automatically generated by the new sensor 20 with additional metadata fields selected by the operator. NITF store 60 may then have the ability to generate a different set of metadata for the new sensor 20 or to produce a set of metadata for the new sensor 20 that is consistent with a standardized template used for other sensors 20.

Thus, by allowing client 100 to search for metadata and retrieve images of different sizes associated with metadata, system 10 may provide for bandwidth-efficient image delivery to a variety of clients 100. Additionally, the ability of NITF store 60 to convert images generated by sensor 20 in a proprietary format viewable only by a special client, into an image in a commonly-used format, a variety of clients 100 may search and display images generated by a variety of sensors 20. As a result, system 10 automates the process of quickly and efficiently delivering images to a wide variety of clients 100. System 10 also provides a standardized way of processing and storing metadata associated with image data generated by a wide variety of sensors 20, allowing clients 100 to search for images relevant to a user's particular need. Additionally, by storing metadata on metadata catalog 80, and images on NITF store 60, system 10 is scalable for use in a wide variety of implementations. Thus, once processed by system 10, image data 25 generated by sensors 20, is readily searchable and able to be displayed by a variety of clients 100. As a result, the use of system 10 may provide numerous benefits, including rapid delivery of specific, relevant images to users, the ability to deliver a standardized image format to a wide variety of clients, advantageous scaling properties, efficient searching of numerous images, and efficient use of image storage and searching resources. Specific embodiments, however, may provide none, some, or all of these benefits.

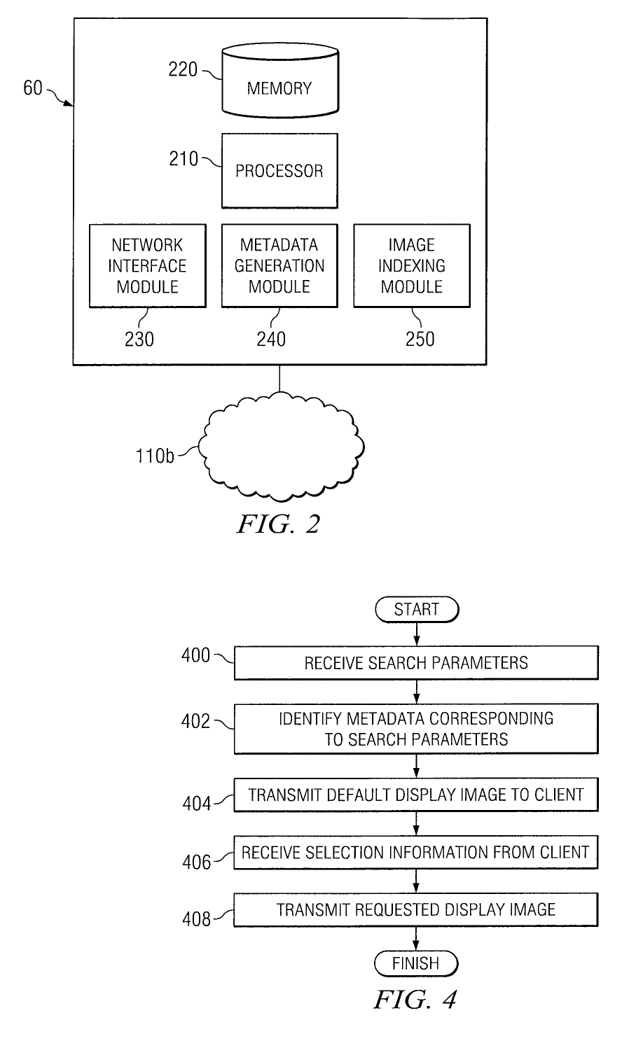

FIG. 2 is a block diagram illustrating in greater detail the contents and operation of a particular embodiment of NITF store 60 shown in FIG. 1. In general, as discussed above with respect to FIG. 1, NITF store 60 processes images for display on client 100 and generates metadata associated with images to facilitate searching by client 100. As shown in FIG. 2, NITF store 60 may include a processor 210, memory 220, a network interface module 230, a metadata generation module 240, and an image indexing module 250.

Processor 210 may represent or include any form of processing component, including general purpose computers, dedicated microprocessors, or other processing devices capable of processing electronic information. Examples of processor 210 include digital signal processors (DSPs), application-specific integrated circuits (ASICs), field-programmable gate arrays (FPGAs), and any other suitable specific or general purpose processors. Although FIG. 2 illustrates a particular embodiment of NITF store 60 that includes a single processor 210, NITF store 60 may, in general, include any suitable number of processors 210.

Memory 220 stores processor instructions, configuration file 75, image conversion instructions, and/or values and parameters that NITF store 60 utilizes during operation. Memory 220 may comprise any collection and arrangement of volatile or non-volatile, components suitable for storing data, such as for example random access memory (RAM) devices, read only memory (ROM) devices, magnetic storage devices, optical storage devices, or any other suitable data storage devices. In particular embodiments, memory 220 may represent, in part, computer-readable media on which computer instructions are encoded. In such embodiments, some or all the described functionality of NITF store 60 may be provided by processor 210 executing the instructions encoded on the described media. Although shown in FIG. 2 as a single component, memory 220 may represent any number of memory elements within, local to, or accessible by NITF store 60. Additionally, although shown in FIG. 2 as being located internal to NITF store 60, memory 220 may represent storage components remote from NITF store 60, such as elements at a Network Attached Storage (NAS), Storage Area Network (SAN), or any other type of remote storage component.

Network interface module 230 couples NITF store 60 to appropriate components of system 10 to facilitate communication between NITF store 60 and metadata catalog 80, temporary storage 50, and/or other appropriate components of system 10 regarding image processing operations performed by NITF store 60. For example, NITF store 60 may receive images from temporary storage 50 and transmit processed metadata 85 to metadata catalog 80 through network interface module 230. In particular embodiments, network interface module 230 includes or represents one or more network interface cards (NICs) suitable for packet-based communication over network 110a and 110b.

Metadata generation module 240 processes received metadata 45 generated by sensor 20 and generates processed metadata 85 that is associated with display image 65. In particular embodiments, NITF store 60 may include multiple metadata generation modules 240 capable of reading, generating and/or otherwise processing metadata associated with various different types of images. In embodiments that include multiple metadata generation modules 240, metadata generation modules 240 may be capable of operating concurrently so that multiple sets of images may be processed simultaneously. As a result, NITF store 60 may provide a robust platform for use in high-traffic systems.

Image indexing module 250 indexes images processed by NITF store 60. In particular embodiments, NITF store 60 may process images received from temporary storage 50 by converting the images into a second image format. Image indexing module 250 may store the image in memory 220 and index the stored images chronologically or in any other appropriate manner.

In general, each of network interface module 230, metadata generation module 240, and image indexing module 250 may represent any appropriate combination of hardware and/or software suitable to provide the described functionality. Additionally, any two or more of network interface module 230, metadata generation module 240, and image indexing module 250 may represent or include common elements. In particular embodiments, network interface module 230, metadata generation module 240, and image indexing module 250 may represent, in whole or in part, software applications being executed by processor 210.

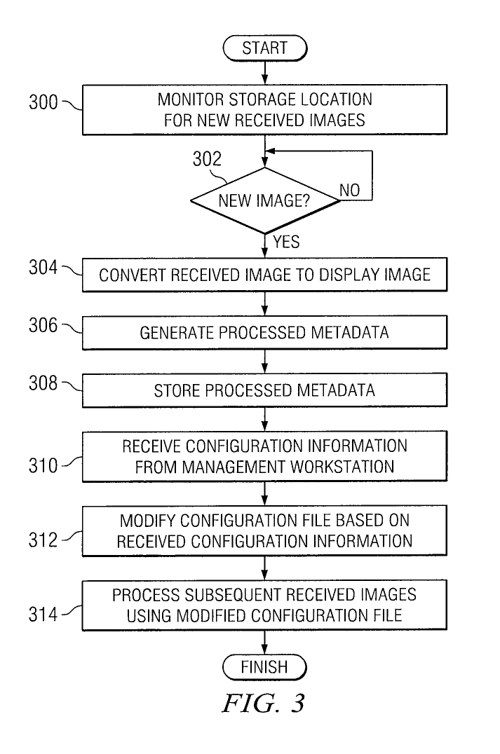

FIG. 3 and FIG. 4 are flowcharts illustrating operation of a particular embodiment of system 10 in processing images. The steps illustrated in FIG. 3 and FIG. 4 may be combined, modified, or deleted where appropriate, and additional steps may also be added to those shown. Additionally, the steps may be performed in any suitable order without departing from the scope of the invention.

Operation, in the illustrated example, begins at step 300 with a particular element of image processing sub-system 12 (e.g., NITF store 60) monitoring a storage location, such as temporary storage 50, for new received images 40 generated by sensors 20. In particular embodiments, sensors 20 may generate image data 25 by photographing objects with a digital or film camera, a video camera, sonar equipment, infrared equipment, or otherwise capturing images in any appropriate manner. Sensors 20 and/or data processing core 30 associate a set of received metadata with each new received image 40.

At step 302, NITF store 60 determines whether a new image is present in temporary storage 50. If NITF store 60 determines that a new image is not present, step 302 is repeated. If NITF store 60 determines that a new received image 40 is present in the monitored location, the new received image 40 may be retrieved by NITF store 60 over network 110a, or in any other appropriate manner.

At step 304, image processing sub-system 12 converts received image 40 received from sensor 20 from a proprietary image format used by sensor 20 into a commonly-used image format supported by client 100. For example, in particular embodiments, image processing sub-system 12 may receive received images 40 in a proprietary format and may convert received image 40 from this proprietary format into a commonly-used format, such as Graphic Interchange Format (GIF), Portable Network Graphics (PNG), Raw Image Format (RAW), Joint Photographic Experts Group (JPG), Motion Picture Experts Group (MPEG), and Tagged Image File Format (TIFF).

At step 306, image processing sub-system 12 generates a set of processed metadata 85 for the new received image 40. In particular embodiments, image processing sub-system 12 may generate processed metadata 85 based on received metadata 45 associated with the new received image 40 and on configuration file 75. For example, configuration file 75 may define metadata fields to be included in processed metadata 85. As noted above, in particular embodiments, configuration file 75 may define fields to be conditionally included in processed metadata 85 depending on the inclusion or exclusion of particular fields in received metadata 45 originally generated for the relevant received image 40. At step 308, image processing sub-system 12 transmits processed metadata 85 to database storage sub-system 14, and database storage sub-system 14 stores processed metadata 85 (e.g., in metadata catalog 80). Image processing sub-system 12 may transmit processed metadata 85 to database storage sub-system 14 by any appropriate protocol, including, but not limited to, File Transfer Protocol (FTP).

At appropriate points during operation, configuration file 75 may be modified by a user, as shown at steps 310-314 in FIG. 3. As noted above, steps 310 and 312 may, in a particular embodiment, occur at any appropriate point during operation, including prior to step 300. In particular embodiments, image processing sub-system 12 receives configuration information from management workstation 70 at step 310. At step 312, image processing sub-system 12 modifies configuration file 75 based on the configuration information received from management workstation 70. Modifications to configuration file 75 may enable image processing sub-system 12 to process additional, fewer, or conditional metadata fields, and as a result, expedite the processing of images received from different types of sensors 20. Thus, the modified configuration file 75 may then be used by image processing sub-system 12 to process subsequent images generated by sensor 20 as shown at step 314.

FIG. 4 is a flowchart illustrating example operation of a particular embodiment of system 10 in which a user searches and retrieves images stored on database storage sub-system 14. As shown in steps 400-408, database storage sub-system 14 stores processed metadata 85 in a database that is searchable by client 100, web server 90, or other appropriate elements of system 10. As a result, users may subsequently perform searches of processed metadata 85 stored by image processing sub-system 12 to identify and retrieve images of interest. At step 400, database storage sub-system 14 receives search parameters 95 from client 100 and/or web server 90. In particular embodiments, web server 90 may receive search parameters 95 from client 100 as part of a search request 92 and process search request 92 to extract search parameters 95. Search request 92 may include search parameters 95 corresponding to one or more sets of processed metadata 85 generated by image processing sub-system 12 and stored in database storage sub-system 14. Web server 90 may then send the extracted search parameters 95 to database storage sub-system 14.

At step 402, database storage sub-system 14, identifies one or more sets of processed metadata 85 that match or otherwise correspond to the received search parameters 95. As shown in step 404, database storage sub-system 14 may then transmit one or more display images 65 associated with the identified sets of metadata to client 100, either directly or indirectly (e.g., through web server 90). In particular embodiments, database storage sub-system 14 transmits, for each of the identified sets of processed metadata 85, a default display image 65 having a default size and/or resolution.

Additionally, instead of transmitting display images 65 to client 100, database storage sub-system 14 may transmit information identifying a location for one or more display images 65 associated with the identified sets of processed metadata 85 to client 100 or another component. The relevant component then retrieves display images 65 from the identified locations. For example, in particular embodiments, database storage sub-system 14 may transmit to web server 90 an image identifier 94 containing one or more path names, each path name indicating the location of a display image 65. Web server 90 may retrieve display images 65 located at each path name in image identifier 94. Web server 90 may then transfer the retrieved display images 65 to client 100 by any appropriate protocol, including, but not limited to, Hyper-Text Transfer Protocol (HTTP).

Client 100 may then display one or more display images 65 received from metadata catalog 80 that correspond to the search parameters 95. For example, in the described embodiment, client 100 displays a default display image 65 associated with each of the sets of processed metadata 85 identified by database storage sub-system 14. The user then selects one of these default images to view in a larger size and/or at a higher resolution. Consequently, as shown at step 406, image processing sub-system 12 receives selection information from client 100, identifying an image and image size or resolution appropriate to meet the user's needs.

After receiving selection information from client 100, database storage sub-system 14 processes the selection information and retrieves a display image 65 having the requested size and/or resolution to client 100. In step 408, database storage sub-system 14 transmits to client 100 a display image 65 (or a location of a display image 65) corresponding to the received selection information. Client 100 may then display the relevant display image 65.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for processing images, comprising:
one or more sensors each operable to generate images;
an image processing sub-system operable to:
receive a first image generated by one of the sensors in a first format, wherein a first set of metadata is associated with the first image;
generate a second set of metadata based on at least the first set of metadata and a configuration file, wherein the configuration file identifies metadata to be included in the second set of metadata;
convert the first image in a first format into a second image in a second format; and
transmit the second image and the second set of metadata to a database storage sub-system;
the database storage sub-system operable to:
store the second set of metadata in a metadata database;
receive search parameters from clients;
identify one or more sets of metadata corresponding to the search parameters; and
transmit one or more images associated with the identified sets of metadata; and
a plurality of clients, each operable to:
transmit search parameters to the database storage sub-system; and
display images received in response to the transmitted search parameters.

2. The system of claim 1, wherein the image processing sub-system is operable to receive the first image by:
detecting the first image in a first format in a storage device, wherein the first image comprises digital image data; and
receiving the first image in a first format from the storage device.

3. The system of claim 1, wherein the image processing sub-system is further operable to:
receive configuration information from a user;
modify the configuration file based on the configuration information received; and
generate a third set of metadata based on at least the first set of metadata and the modified configuration file;

4. The system of claim 1, wherein the image processing sub-system is further operable to update metadata sets based on at least the modified configuration file.

5. The system of claim 1, wherein the configuration file comprises an XML-based file.

6. The system of claim 1, wherein:
the configuration file identifies a condition associated with at least one element of metadata; and
the image processing system is further operable to generate the second set of metadata based at least on whether the condition is satisfied.

7. The system of claim 1, wherein the client is operable to display a plurality of images by:
displaying an image corresponding to each of the identified sets of metadata;
receiving selection information from a user, wherein the selection information indicates a selected image size to display;
transmitting the selection information to the database storage sub-system; and
wherein the database storage sub-system is further operable to transmit an image corresponding to the selected image size in response to receiving the selection information.

8. The system of claim 1, wherein the image processing sub-system is operable to convert the first image by:
converting the first image into a second image having a first size; and
converting the first image into a third image in the second format, wherein the third image has a second size.

9. A method for processing images, comprising the steps of:
receiving from one of a plurality of sensors a first image in a first format, wherein a first set of metadata is associated with the first image;
generating a second set of metadata based on at least the first set of metadata and a configuration file, wherein the configuration file identifies metadata to be included in the second set of metadata;
converting the first image in a first format into a second image in a second format;
storing the second set of metadata in a metadata database;
receiving search parameters from a client;
identifying one or more sets of metadata corresponding to the search parameters; and
transmitting one or more images associated with the identified sets of metadata to the client.

10. The method of claim 9, wherein receiving a first image comprises the steps of:
detecting the first image in a first format in a storage device, wherein the first image comprises digital image data; and
receiving the first image in a first format from the storage device.

11. The method of claim 9, further comprising the steps of:
receiving configuration information from a user;
modifying the configuration file based on the configuration information received; and
receiving from one of a plurality of sensors a third image in a first format wherein a third set of metadata is associated with the third image;
generating a fourth set of metadata based on at least the third set of metadata and the modified configuration file.

12. The method of claim 11, further comprising the step of updating metadata sets based on at least the modified configuration file.

13. The method of claim 9, wherein the configuration file comprises an XML-based file.

14. The method of claim 9, wherein:
the configuration file identifies a condition associated with at least one element of metadata; and
generating the second set of metadata comprises generating the second set of metadata based at least on whether the condition is satisfied.

15. The method of claim 9, wherein transmitting to a client one or more images comprises the steps of:
displaying an image corresponding to each of the identified sets of metadata;
receiving selection information from a user, wherein the selection information indicates a selected image size to display;
transmitting the selection information to the database storage sub-system; and
transmitting, in response to receiving the selection information, one or more images corresponding to the selected image size.

16. The method of claim 9, wherein converting the first image comprises the steps of:
converting the first image into a second image having a first size;
converting the image in a first format into a third image in the second format, wherein the third image has a second size.

17. Logic for processing images, the logic encoded on tangible media and operable, when executed on a processor, to:
receive from one of a plurality of sensors a first image in a first format, wherein a first set of metadata is associated with the first image;
generate a second set of metadata based on at least the first set of metadata and a configuration file, wherein the configuration file identifies metadata to be included in the second set of metadata;
convert the first image in a first format into a second image in a second format;
store the second set of metadata in a metadata database;
receive search parameters from clients;
identify one or more sets of metadata corresponding to the search parameters; and
transmit to a client one or more images associated with the identified sets of metadata.

18. The logic of claim 17, wherein the logic is operable to receive a first image by:
detecting the first image in a first format in a storage device, wherein the first image comprises digital image data; and
receiving the first image in a first format from the storage device.

19. The logic of claim 17, wherein the logic is further operable to:
receive configuration information from a user;
modify the configuration file based on the configuration information received; and
generate a third set of metadata based on at least the first set of metadata and the modified configuration file.

20. The logic of claim 19, wherein the logic is further operable to update metadata sets based on at least the modified configuration file.

21. The logic of claim 17, wherein the logic is operable to generate a second set of metadata by using an XML-based configuration file for the configuration file.

22. The logic of claim 17, wherein:
the configuration file identifies a condition associated with at least one element of metadata; and
the logic is operable to generate the second set of metadata by generating the second set of metadata based at least on whether the condition is satisfied.

23. The logic of claim 17, wherein the logic is operable to transmit to a client one or more images by:
displaying an image corresponding to each of the identified sets of metadata;
receiving selection information from a user, wherein the selection information indicates a selected image size to display;
transmitting the selection information to the database storage sub-system; and
transmitting, in response to receiving the selection information, one or more images corresponding to the selected image size.

24. The logic of claim 17, wherein the logic is further operable to convert the first image by:
converting the first image into a second image having a first size; and
converting the image in a first format into a third image in the second format, wherein the third image has a second size.

25. A system for processing images, comprising:
means for receiving from one of a plurality of sensors a first image in a first format, wherein a first set of metadata is associated with the first image;
means for generating a second set of metadata based on at least the first set of metadata and a configuration file, wherein the configuration file identifies metadata to be included in the second set of metadata;
means for converting the first image in a first format into a second image in a second format;
means for storing the second set of metadata in a metadata database;
means for receiving search parameters from clients;
means for identifying one or more sets of metadata corresponding to the search parameters; and
means for transmitting to a client one or more images associated with the identified sets of metadata.
